(19) United States
(12) Patent Application Publication
(10) Pub. No.: US 2010/0014160 A1
(43) Pub. Date: Jan. 21, 2010

(54) Extendable telescope

(76) Inventor: William Yang, Danshuei Township (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 12/219,091

(22) Filed: Jul. 16, 2008

(51) Int. Cl. G02B 23/00

(52) U.S. Cl. 359/399; 359/405

(57) ABSTRACT

An extendable telescope comprises a main barrel having a compensation lens group thereinside; an auxiliary barrel slidably disposed within the main barrel, the auxiliary barrel having a main lens group thereinside corresponding to the compensation lens group; and an assembling structure disposed on an end of the main barrel, the assembling structure being corresponding to the compensation lens group and the main lens group. Further, an image capturing unit can be assembled on the assembling structure. By the above-mentioned structure, no moment generates on the end of the main barrel and thus the main barrel and the auxiliary barrel carry their straight states to maintain the precision of the focal length.

### BACKGROUND OF THE INVENTION

1. Field of the Invention

The present invention relates to an extendable telescope, and in particular to a telescope that is used for observing focal images by adjusting the distance of the lens in a pushing and drawing manner.

2. Description of Prior Art

A telescope is an instrument designed for the observation of remote objects by using optical lenses. A user has to adjust the distance between the lenses to gather and focus light so that focal image can be observed and taken as a photograph.

The application of telescopes covers a wide range of technical fields, such as military detection, animal or plant observation and astronomy. Besides observing by eyes, image capturing units, such as digital cameras and digital video cameras are mounted on telescopes for recording images of an object on recording media such as a compact disk (CD).

Please refer to FIG. 1. The traditional telescope has a main barrel 1a, an auxiliary barrel 2a and an assembling structure 3a. The main barrel 1a has a main lens group 11a thereinside, and the auxiliary barrel 2a has a compensation lens group 21a thereinside. The auxiliary barrel 2a is slidably disposed within the main barrel 1a. The assembling structure 3a is disposed on an end of the auxiliary barrel 2a for connecting to the image capturing units.

The user can push or draw the auxiliary barrel 2a relatively to the main barrel 1a in order to adjust the distance between the main lens group and the compensation lens group 21a until he sees the focal image.

However, when an image capturing unit is disposed with the assembling structure 3a, a moment is generated on the end of the auxiliary barrel 2a because of the weight of the image capturing unit. Therefore, the auxiliary barrel 2a is bending so that the optical axis of the compensation lens group 21a shifts relatively the optical axis of the main lens group 11a.

Therefore, in view of this, the inventor proposes the present invention to overcome the above problems based on his expert experience and deliberate research.

### SUMMARY OF THE INVENTION

The primary object of the present invention is provided for an extendable telescope. The barrel is prevented from bending resulted from the weight of the image capturing unit so that the barrel can maintain its straight state in order to hold the precision of the focal length.

In order to achieve the above object, the present invention provides an extendable telescope. The extendable telescope comprises a main barrel having a compensation lens group thereinside; an auxiliary barrel slidably disposed within the main barrel, the auxiliary barrel having a main lens group thereinside corresponding to the compensation lens group; and an assembling structure disposed on an end of the main barrel, the assembling structure being corresponding to the compensation lens group and the main lens group.

In the present invention, the assembling structure is disposed on one end of the main barrel. When an image capturing unit is engaged with the assembling structure, there is no moment generated on the end of the main barrel so that the main barrel and the auxiliary barrel carry their straight states and the precision of adjusting focal length.

Moreover, the diameter of the main barrel is larger than that of the auxiliary barrel, and thus the diameter of the compensation lens group is equal to or larger than that of the main lens group so that light passing the main lens group is totally received by the compensation lens group. Thus, the problem of insufficient light reaching the compensation lens group is solved, and further the phenomenon of optical aberration image distortion and vignetting image are eliminated

In order to better understand the characteristics and technical contents of the present invention, a detailed description thereof will be made with reference to the accompanying drawings. However, it should be understood that the drawings and the description are illustrative but not used to limit the scope of the present invention.

### BRIEF DESCRIPTION OF THE DRAWINGS

FIG. 1 is a side view showing the telescope according to the prior art.

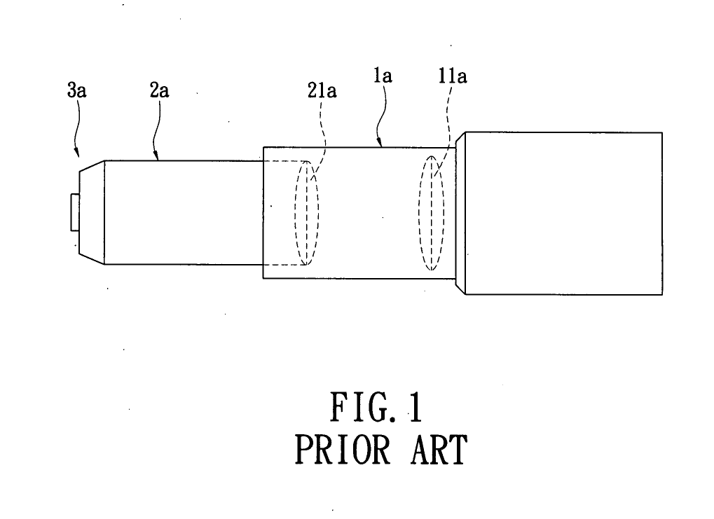

FIG. 2 is a side view showing the extendable telescope according to the present invention.

FIG. 3 is a top view showing the extendable telescope according to the present invention.

FIG. 4 is schematic representation showing the extendable telescope with an image capturing unit according to the present invention.

### DETAILED DESCRIPTION OF THE INVENTION

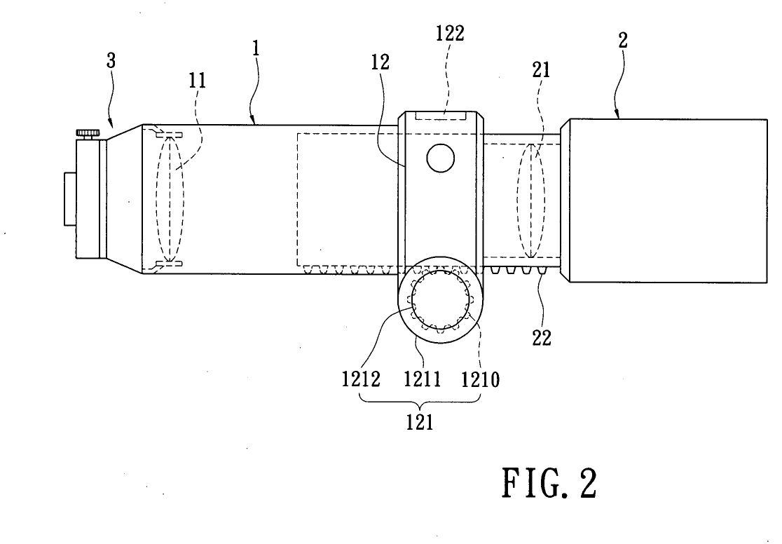

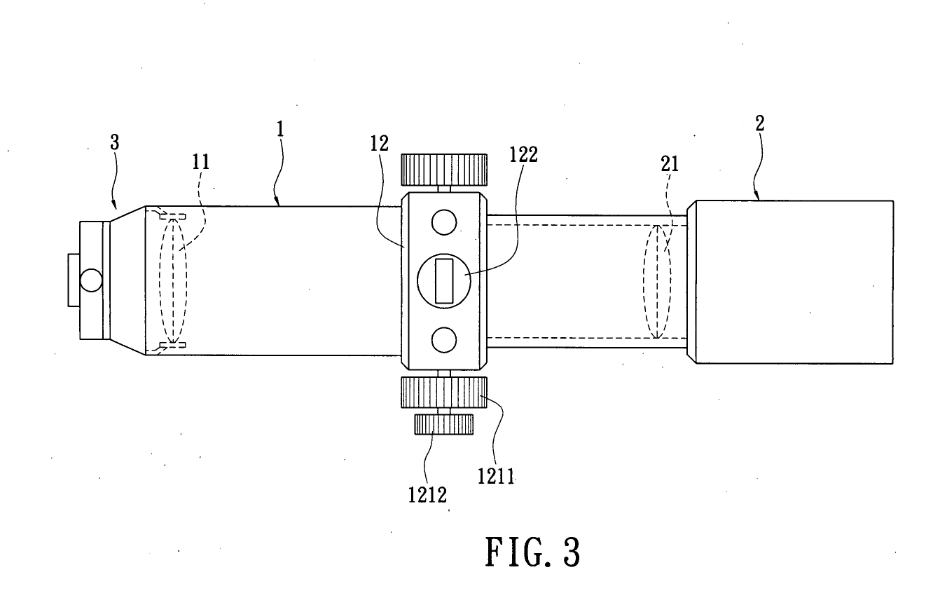

Please refer to FIGS. 2 and 3, the invention discloses an extendable telescope which comprises a main barrel 1, an auxiliary barrel 2 and an assembling structure 3.

In this embodiment, the main barrel 1 is an empty tubular structure and the assembling structure 3 disposed on an end (rear end) of the main barrel 1. The position of the assembling structure 3 is corresponding to the following-mentioned compensation lens group 11 and main lens group 21 so that the focal image can be detected. The main barrel 1 has a compensation lens group 11 and an adjustment base 12. The compensation lens group 11 is secured on the inner wall of the main barrel 1 in close proximity to the assembling structure 3. The adjustment base 12 is disposed on the other end (front end) of the main barrel 1.

The adjustment base 12 has an adjustment knob group 121 and a focal length display unit 122. The adjustment knob group 121 has a gear 1210, a coarse adjustment knob 1211 and a fine adjustment knob 1212. The gear 1210 is disposed on the bottom of the adjustment base 12 and connects to the coarse adjustment knob 1211 and the fine adjustment knob 1212. The diameter of the coarse adjustment knob 1211 is larger than that of the fine adjustment knob 1212. The position of the coarse adjustment knob 1211 is between the fine adjustment knob 1212 and the gear 1210. In other words, the coarse adjustment knob 1211 is disposed nearer to the main barrel 1 than the fine adjustment knob 1212.

The focal length display unit 122 is disposed on the top of the adjustment base 12. The focal length display unit 122 is used for detecting the distance of the auxiliary barrel 2 sliding into the main barrel 1 in an electromagnetic manner and further representing the data of focal distance thereon. It is convenient for users to adjust the distance.

The auxiliary barrel 2 is slidably disposed within the main barrel 1. The auxiliary barrel 2 has a main lens group 21 and a rack 22. The main lens group 21 is secured inside the auxiliary barrel 2 and the position of the main lens group 21 is corresponding to the compensation lens group 11.

Furthermore, the rack 22 is disposed on the bottom of the auxiliary barrel 2 and is corresponding to the gear 1210. The rack 22 can engage with the gear 1210. By the above-mentioned structure, the user can turn the coarse adjustment knob 1211 with larger diameter so as to move the auxiliary barrel 2 for a longer distance. Alternatively, the user can turn the fine adjustment knob 1212 with smaller diameter for moving the auxiliary barrel 2 for a smaller distance. Accordingly, the distance between the compensation lens group 11 and the main lens group 21 is adjusted so that the user can see a focal image.

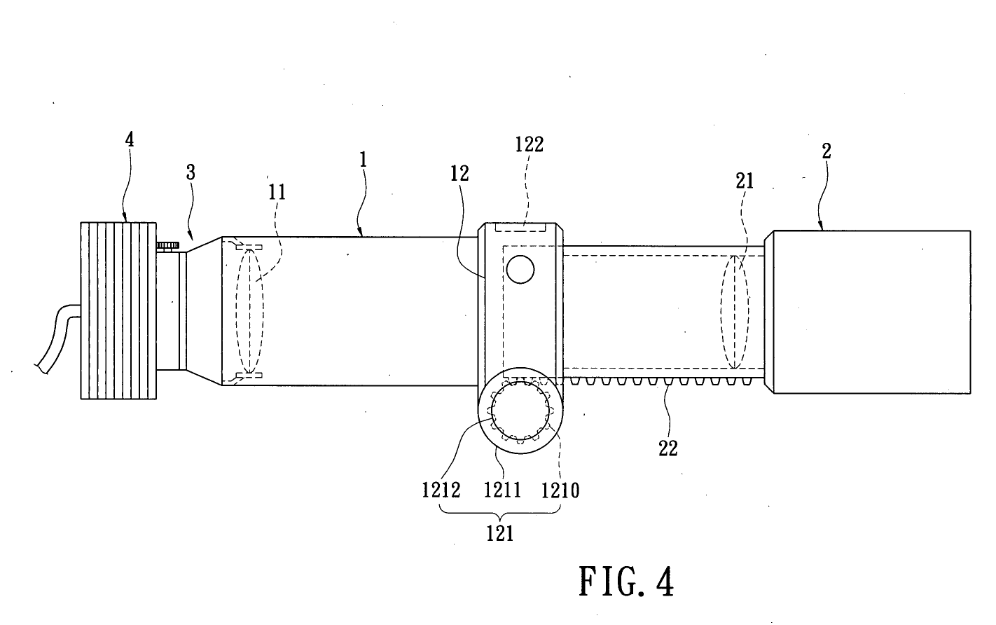

Please refer to FIG. 4, the extendable telescope further has an image capturing unit 4 disposed on the assembling structure 3. The image capturing unit 4, for example, is a digital camera or a digital video camera. The optical device of the image capturing unit 4 can receive the image focusing by the main lens group 21 and the compensation lens group 11 so that the image can be recorded by the image capturing unit 4.

To sum up, the present invention has the following advantages.

Because that the assembling structure 3 is disposed on the main barrel 1 (the main barrel 1 is called a fixed barrel), the weight of the image capturing unit 4 assembled with the assembling structure 3 does not force on the end of the main barrel 1. In other words, the main barrel 1 is prevented from bending so that the main barrel 1 can carry its straight state with the auxiliary barrel 2. Therefore, the precise optical axis can be maintained when the auxiliary barrel 2 slides.

Moreover, the diameter of the main barrel 1 is larger than that of the auxiliary barrel 2 and thus the diameter of the compensation lens group 11 is larger than that of the main lens group 21 so that light passing the main lens group 21 is totally received by the compensation lens group 11. Thus, the problem of insufficient light reaching the compensation lens group 11 is solved, and further the phenomenon of optical aberration image distortion and vignetting image are totally eliminated.

Even though the present invention has been described with reference to the foregoing preferred embodiment, it shall be understood that the invention is not limited to the details thereof. Various equivalent variations and modifications may occur to those skilled in this art in view of the teachings of the present invention. Thus, all such variations and equivalent modifications are also embraced within the scope of the invention as defined in the appended claims.

What is claimed is:

1. An extendable telescope, comprising:
a main barrel having a compensation lens group thereinside;
an auxiliary barrel slidably disposed within the main barrel, the auxiliary barrel having a main lens group thereinside corresponding to the compensation lens group; and
an assembling structure disposed on an end of the main barrel, the image transmitting structure corresponding to the compensation lens group and the main lens group.

2. The extendable telescope according to claim 1, wherein the main barrel further has an adjustment base, the adjustment base has an adjustment knob group, the adjustment knob group has a gear, and the auxiliary barrel has a rack engaged with the gear.

3. The extendable telescope according to claim 2, wherein the adjustment knob group has a coarse adjustment knob and a fine adjustment knob.

4. The extendable telescope according to claim 3, wherein the adjustment base further has a focal length display unit thereon.

5. The extendable telescope according to claim 1, further comprising an image capturing unit wherein the image capturing unit is disposed with the assembling structure.

6. The extendable telescope according to claim 5, wherein the image capturing unit is a digital camera or a digital video camera.

7. The extendable telescope according to claim 1, wherein a diameter of the compensation lens group is larger than or equal to a diameter of the main lens group.
